(19) United States
(12) Patent Application Publication
(10) Pub. No.: US 2009/0259788 A1
(43) Pub. Date: Oct. 15, 2009

(54) MOTHERBOARD HAVING TIME CALCULATING DEVICE AND TIME CALCULATING METHOD THEREOF

(75) Inventors: Yu-Chen Lee, Taipei (TW); Chien-Shien Lin, Taipei (TW); Chao-Chung Wu, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTeK COMPUTER INC., Taipei (TW)

(21) Appl. No.: 12/400,503

(22) Filed: Mar. 9, 2009

(30) Foreign Application Priority Data
Apr. 14, 2008 (TW) 097113478

(51) Int. Cl. G06F 13/00; G06F 12/02

(52) U.S. Cl. 710/302; 711/103; 711/E12.008

(57) ABSTRACT

A motherboard having a time calculating device is provided. The motherboard includes a central processing unit, a chipset and a micro controller. The chipset is connected to the central processing unit. The micro controller includes a time counter and a non-volatile storage unit storing therein a first value. The time counter starts to count time when the operating state of the motherboard detected by the micro controller is switched from a power-off state to a power-on state. The time counter stops counting time and defines the counting value as a second value when the operating state of the motherboard detected by the micro controller is switched from the power-on state to the power-off state. The micro controller updates the first value by adding the first value and the second value and stores the updated first value to the non-volatile storage unit.

### FIELD OF THE INVENTION

The present invention relates to a motherboard, and more particularly to a motherboard having a time calculating device. The present invention also relates to a time calculating method of the motherboard.

### BACKGROUND OF THE INVENTION

Generally, the manufacturers of the motherboards fail to fully realize the use conditions of the motherboards after the electronic appliances (e.g. computers) containing the motherboards have been sold to the users. If a motherboard has a breakdown, the maintenance sector is usually unable to acquire enough information associated with the use condition of the motherboard. Under this circumstance, the maintenance sector needs to take a long-term maintenance process to repair the motherboard.

Moreover, most computer hosts that contain motherboards are commercially available in the electronic market. If a secondhand motherboard is disguised as a new one, or if a secondhand motherboard is integrated into a new computer host, the user usually fails to realize whether the motherboard or the computer host is a new product.

For obviating the drawbacks encountered from the prior art, there is a need of a device and a method for acquiring the information associated with the use condition of the motherboard.

### SUMMARY OF THE INVENTION

In accordance with an aspect of the present invention, there is provided a motherboard having a time calculating device. The motherboard includes a central processing unit, a chipset and a micro controller. The chipset is connected to the central processing unit. The micro controller includes a time counter and a non-volatile storage unit storing therein a first value. The time counter starts to count time when the operating state of the motherboard detected by the micro controller is switched from a power-off state to a power-on state. The time counter stops counting time and defines the counting value as a second value when the operating state of the motherboard detected by the micro controller is switched from the power-on state to the power-off state. The micro controller updates the first value by adding the first value and the second value and stores the updated first value to the non-volatile storage unit.

In accordance with another aspect of the present invention, there is provided a motherboard having a time calculating device. The motherboard includes a central processing unit, a chipset and a micro controller. The chipset is connected to the central processing unit. The micro controller includes a time counter and a non-volatile storage unit storing therein a first value. The time counter starts to count time from the first value when the operating state of the motherboard detected by the micro controller is switched from a power-off state to a power-on state. The time counter stops counting time and defines the counting value as an updated first value when the operating state of the motherboard detected by the micro controller is switched from the power-on state to the power-off state. The micro controller stores the updated first value to the non-volatile storage unit.

In accordance with a further aspect of the present invention, there is provided a time calculating method of a motherboard. The time calculating method includes steps of starting to count time when the operating state of the motherboard is in a power-on state, stopping counting time and defining the counting value as a current run time when the operating state of the motherboard is in a power-off state, acquiring a first value that has been stored in a non-volatile storage unit of the motherboard, updating the first value by adding the first value and the current run time, and storing the updated first value to the non-volatile storage unit.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a motherboard having a time calculating device according to a first preferred embodiment of the present invention; and

FIG. 2 is a schematic functional block diagram illustrating a motherboard having a time calculating device according to a second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

For obviating the drawbacks encountered from the prior art, the present invention provides a motherboard having a time calculating device. When a power switch of a computer host is pressed down by a user to power on the computer host, the time calculating device of the motherboard starts to count time. When the computer host is powered off, the time calculating device stops counting time. The run time of operating the motherboard from the beginning to the end of the computer host at this operating routine is obtained. The run time at this operating routine and the previously accumulated use time are added to obtain a total use time. The total use time is recorded in a storage device. According to the information (e.g. the total use time) that is stored in the storage device, the user or the motherboard maintenance sector may realize the use condition of the motherboard.

As known, the power supply of the computer host can provide a standby power to the motherboard. Generally, the standby power is also transmitted to the super I/O, the keyboard, the mouse and so on. As a consequence, the computer host can successfully detect the presence of the keyboard and the mouse during the computer host is powered on and an initialization process is performed. Meanwhile, the keyboard and the mouse will be normally operated. Since the time calculating device of the motherboard of the present invention is also connected to the standby power source, the timing of powering on or off the computer host is effectively realized.

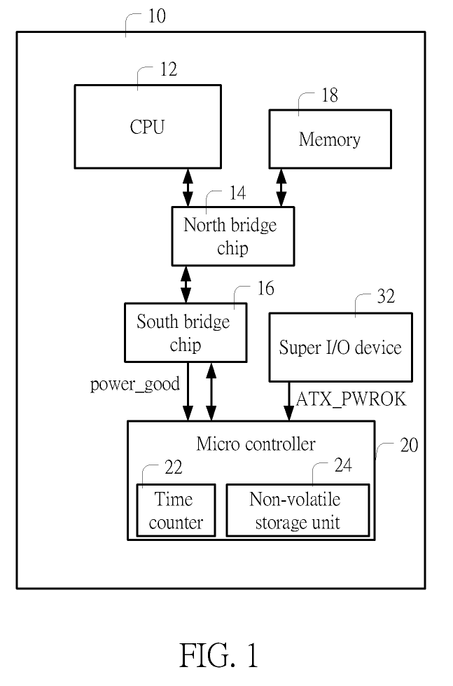

FIG. 1 is a schematic functional block diagram illustrating a motherboard having a time calculating device according to a first preferred embodiment of the present invention. As shown in FIG. 1, a central processing unit (CPU) 12, a chipset including a north bridge chip 14 and a south bridge chip 16, a memory 18, a micro controller 20 and a super I/O device 32 are mounted on the motherboard 10. The north bridge chip 14 is connected to the central processing unit 12, the memory 18 and the south bridge chip 16. The micro controller 20 is connected to the south bridge chip 16 and the super I/O device 32. The micro controller 20 comprises a time counter 22 and a non-volatile storage unit 24. A first value denoting the previously accumulated use time of the computer host is stored in the non-volatile storage unit 24. An exemplary non-volatile storage unit 24 includes but is not limited to a flash memory or an electrically-erasable programmable read-only memory.

In this embodiment, the micro controller 20 is connected to a first pin of the south bridge chip 16. An example of the first pin is a PWRGD (power_good) pin or a PWROK pin. Alternatively, the micro controller 20 may be connected to a SLP (e.g. SLP3 or SLP4) pin of the south bridge chip 16. Consequently, the micro controller 20 may continuously count time even if the computer system is in a sleep mode. In addition, the micro controller 20 is also connected to a second pin of the super I/O device 32. An example of the second pin is an ATX_PWROK pin. When a power switch of the computer host is pressed down to power on the computer host, the micro controller 20 may monitor the activation of the first pin or the second pin. At this moment, the time counter 22 of the micro controller 20 starts to count time. Whereas, when the computer host is powered off, the time counter 22 of the micro controller 20 stops counting time. At the moment when the time counter 22 stops counting time, the counting value shown on the time counter 22 of the micro controller 20 indicates a run time of the computer host at this operating routine. This counting value is also defined as a second value.

Since the first value denoting the previously accumulated use time of the computer host has been stored in the non-volatile storage unit 24 of the micro controller 20 and the micro controller 20 is connected to the standby power source, the micro controller 20 will read out the first value from the non-volatile storage unit 24 after the computer host is powered on. Next, the micro controller 20 updates the first value by adding the first value and the second value, thereby obtaining an updated first value. The micro controller 20 will re-store the updated first value into the non-volatile storage unit 24. According to the updated first value in the non-volatile storage unit 24, the total use time of the motherboard 10 is realized.

In some embodiments, the micro controller 20 can read out the first value from the non-volatile storage unit 24 immediately after the computer host is powered on. At this moment, the time counter 22 of the micro controller 20 starts to count time and the total use time of the motherboard 10 is accumulated from the first value. When the computer host is powered off, the counting value shown on the time counter 22 of the micro controller 20 indicates the total use time of the computer host. This counting value is can be deemed as an updated first value. The micro controller 20 will re-store the updated first value into the non-volatile storage unit 24. According to the updated first value in the non-volatile storage unit 24, the total use time of the motherboard 10 is realized.

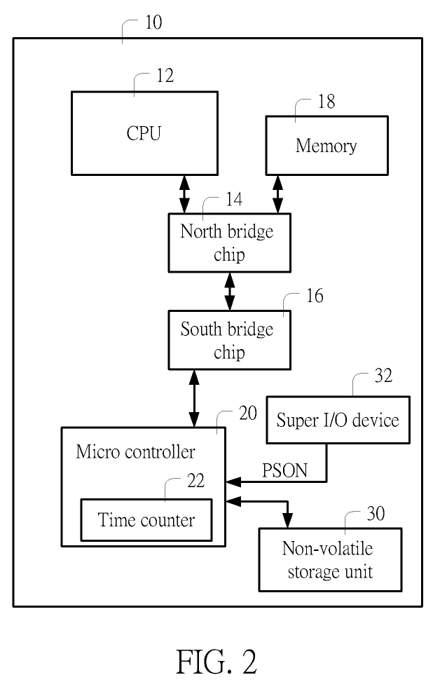

FIG. 2 is a schematic functional block diagram illustrating a motherboard having a time calculating device according to a second preferred embodiment of the present invention. As shown in FIG. 2, a central processing unit (CPU) 12, a chipset including a north bridge chip 14 and a south bridge chip 16, a memory 18, a micro controller 20, a non-volatile storage unit 30 and a super I/O device 32 are mounted on the motherboard 10. The north bridge chip 14 is connected to the central processing unit 12, the memory 18 and the south bridge chip 16. The micro controller 20 comprises a time counter 22. The micro controller 20 is connected to the south bridge chip 16, the super I/O device 32 and the non-volatile storage unit 30. A first value denoting the previously accumulated use time of the computer host is stored in the non-volatile storage unit 24.

In this embodiment, the micro controller 20 is connected to a second pin of the super I/O device 32. An example of the second pin is a PSON signal pin or an ATX_PWROK pin. When a power switch of the computer host is pressed down to power on the computer host, the micro controller 20 may monitor the activation of the second pin of the super I/O device 32. At this moment, the time counter 22 of the micro controller 20 starts to count time. Whereas, when the computer host is powered off, the time counter 22 of the micro controller 20 stops counting time. At the moment when the time counter 22 stops counting time, the counting value shown on the time counter 22 of the micro controller 20 indicates a run time of the computer host at this operating routine. This counting value is also defined as a second value.

Since the first value denoting the previously accumulated use time of the computer host has been stored in the non-volatile storage unit 30 and the micro controller 20 is connected to the standby power source, the micro controller 20 will read out the first value from the non-volatile storage unit 30 after the computer host is powered on. Next, the micro controller 20 updates the first value by adding the first value and the second value, thereby obtaining an updated first value. The micro controller 20 will re-store the updated first value into the non-volatile storage unit 30. According to the updated first value in the non-volatile storage unit 30, the total use time of the motherboard 10 is realized.

In some embodiments, the micro controller 20 can read out the first value from the non-volatile storage unit 30 immediately after the computer host is powered on. At this moment, the time counter 22 of the micro controller 20 starts to count time and the total use time of the motherboard 10 is accumulated from the first value. When the computer host is powered off, the counting value shown on the time counter 22 of the micro controller 20 indicates the total use time of the computer host. This counting value is can be deemed as an updated first value. The micro controller 20 will re-store the updated first value into the non-volatile storage unit 30. According to the updated first value in the non-volatile storage unit 30, the total use time of the motherboard 10 is realized.

Before the motherboard 10 is put on the market, the first value needs to be zeroed by the manufacturer of the motherboard 10. As long as the motherboard 10 is operated, the micro controller 20 continuously counts up the first value. In a case that a motherboard is commercially available, the user can realize the use condition of the motherboard according to the first value recorded in the non-volatile storage unit of the motherboard, thereby further discriminating whether the motherboard is second-hand.

Furthermore, the motherboard maintenance sector may acquire the information associated with the correlation between the first value (i.e. the accumulated use time of the motherboard) and the use life of some specified electronic components on the motherboard. In a case that a damaged motherboard is sent to the motherboard maintenance sector for repair, the maintenance worker may quickly figure out the possibly damaged component of the motherboard according to the accumulated use time of the motherboard. As a result, the efficiency of repairing the motherboard is largely increased.

From the above embodiments, since the motherboard of the present invention has a time calculating device, the user and the motherboard maintenance sector can realize the accumulated use time of the motherboard and the use condition of the motherboard. According to the accumulated use time of the motherboard, the efficiency of repairing the motherboard is largely increased.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A motherboard having a time calculating device, the motherboard comprising:
a central processing unit;
a chipset connected to the central processing unit; and
a micro controller comprising a time counter and a non-volatile storage unit storing therein a first value, wherein the time counter starts to count time when the operating state of the motherboard detected by the micro controller is switched from a power-off state to a power-on state, the time counter stops counting time and defines the counting value as a second value when the operating state of the motherboard detected by the micro controller is switched from the power-on state to the power-off state, and the micro controller updates the first value by adding the first value and the second value and stores the updated first value to the non-volatile storage unit.

2. The motherboard according to claim 1 wherein the non-volatile storage unit is a flash memory or an electrically-erasable programmable read-only memory.

3. The motherboard according to claim 1 wherein the micro controller is connected to a first pin of the chipset for detecting whether the operating state of the motherboard is in the power-on state.

4. The motherboard according to claim 1 further comprising a super I/O device, wherein the micro controller is connected to a second pin of the super I/O device for detecting whether the operating state of the motherboard is in the power-on state.

5. The motherboard according to claim 4 wherein the super I/O device and the micro controller are connected to a standby power source.

6. The motherboard according to claim 1 further comprising a memory connected to the chipset.

7. The motherboard according to claim 6 wherein the chipset comprises a north bridge chip and a south bridge chip, which are connected to the micro controller.

8. A motherboard having a time calculating device, the motherboard comprising:
a central processing unit;
a chipset connected to the central processing unit; and
a micro controller comprising a time counter and a non-volatile storage unit storing therein a first value, wherein the time counter starts to count time from the first value when the operating state of the motherboard detected by the micro controller is switched from a power-off state to a power-on state, the time counter stops counting time and defines the counting value as an updated first value when the operating state of the motherboard detected by the micro controller is switched from the power-on state to the power-off state, and the micro controller stores the updated first value to the non-volatile storage unit.

9. The motherboard according to claim 8 wherein the non-volatile storage unit is a flash memory or an electrically-erasable programmable read-only memory.

10. The motherboard according to claim 8 wherein the micro controller is connected to a first pin of the chipset for detecting whether the operating state of the motherboard is in the power-on state.

11. The motherboard according to claim 8 further comprising a super I/O device, wherein the micro controller is connected to a second pin of the super I/O device for detecting whether the operating state of the motherboard is in the power-on state.

12. The motherboard according to claim 11 wherein the super I/O device and the micro controller are connected to a standby power source.

13. The motherboard according to claim 8 further comprising a memory connected to the chipset.

14. The motherboard according to claim 13 wherein the chipset comprises a north bridge chip and a south bridge chip, which are connected to the micro controller.

15. A time calculating method of a motherboard, comprising steps of:
starting to count time when the operating state of the motherboard is in a power-on state;
stopping counting time and defining the counting value as a current run time when the operating state of the motherboard is in a power-off state;
acquiring a first value that has been stored in a non-volatile storage unit of the motherboard;
updating the first value by adding the first value and the current run time; and
storing the updated first value to the non-volatile storage unit.

16. The time calculating method according to claim 15 wherein the step of storing the updated first value to the non-volatile storage unit includes replacing the first value with the updated first value.

17. The time calculating method according to claim 15 wherein the non-volatile storage unit is a flash memory or an electrically-erasable programmable read-only memory.

18. The time calculating method according to claim 15 wherein the motherboard further comprises a south bridge chip, and the south bridge chip has a first pin for detecting whether the operating state of the motherboard is in the power-on state.

19. The time calculating method according to claim 15 wherein the motherboard further comprises a super I/O device, and the super I/O device has a second pin for detecting whether the operating state of the motherboard is in the power-on state.
